(19) United States
(12) Patent Application Publication
(10) Pub. No.: US 2019/0127630 A1
(43) Pub. Date: May 2, 2019

(54) METHOD FOR PROPPANT ADDITION TO A FRACTURING FLUID

(71) Applicant: Robin TUDOR, Sundre (CA)

(72) Inventor: Robin TUDOR, Sundre (CA)

(21) Appl. No.: 16/091,826

(22) PCT Filed: Apr. 10, 2017
(86) PCT No.: PCT/CA2017/050438

§ 371 Date: Oct. 5, 2018

(30) Foreign Application Priority Data
Apr. 20, 2016 (CA) 2927768

(51) Int. Cl. C09K 8/80; C09K 8/72; C09K 8/62; C09K 8/64; B01D 11/02

(52) U.S. Cl. CPC C09K 8/80; C09K 8/72; C09K 8/62; E21B 43/267; B01D 11/0215; B01D 11/028; C09K 8/64

(57) ABSTRACT

A proppant slurry for fracturing a subterranean formation is prepared by preparing a mixture comprising the proppant and a transfer fluid and transferring the proppant from the mixture to a base fluid, such as a liquefied gas or an acid. The proppant can be mixed with the transfer fluid to form a transfer slurry, the transfer slurry and the base fluid can be introduced into a proppant exchange device, and the proppant can be transferred from the transfer slurry to the base fluid to form the proppant slurry. The base fluid and the proppant slurry can be maintained in a closed system, out of contact with the surrounding environment, while the proppant can be added continuously to the base fluid. A proppant exchange device for use in the method is also provided.

### BACKGROUND

The present application is directed to a method of adding proppant to a fracturing fluid. More specifically, the present application provides a method of transferring proppant from a transfer fluid mixture to a base fluid to form a proppant slurry.

Fracturing fluids are used in the process of hydraulic fracturing to facilitate the recovery of hydrocarbon deposits within a subterranean formation. Fracturing fluid is generally pumped into the formation at high pressure so as to force the opening of cracks or fissures within the formation, allowing hydrocarbons to flow more easily from the formation. Fracturing fluids often contain large amounts of water, although alcohols such as methanol, hydrocarbons such as diesel and liquefied propane or methane, or liquefied gases such as nitrogen and carbon dioxide can also be used as a base fluid. In addition, acids such as hydrochloric acid (HCl) or hydrofluoric acid (HF) can be used to react with carbonate minerals in formations such as limestone or dolomite, or with silicate minerals in formations such as sandstone, thereby dissolving part of the formation and creating fractures.

Often, fracturing fluids contain a suspended granular solid or proppant which remains in the formation once the fracturing fluid has been removed, where the proppant acts to prop open the channels which are formed, allowing the hydrocarbon deposits in the well to flow more readily to the surface. In addition, fracturing fluids often contain additives to control viscosity and other properties, so that adequate quantities of proppant can remain suspended while the fluid is being pumped into the formation but the proppant can be deposited within the cracks and fissures formed and the remaining components can be readily removed from the fractured formation. Such additives can include gelling or thickening agents to increase viscosity, facilitating the suspension of proppant for transport into the formation, and breakers to reduce viscosity, thereby allowing proppant to settle out and be deposited in the fractures and facilitating the recovery of used fracturing fluid.

Water-based fracturing fluids are relatively economical to use, but some additives used with water-based fluids are toxic or can cause harm to the environment, and it can be necessary to dispose of large quantities of recovered contaminated water once a fracturing job is complete, with additional negative consequences to the environment. Furthermore, water-based fracturing fluids may leave residues within the channels formed, and can cause damage to the formation. Some of the disadvantages of water-based fracturing fluids can be overcome by using base fluids which are gases at normal ambient atmospheric pressures and temperatures, but which can be liquefied under increased pressure and/or reduced temperatures or used under pressure in gaseous form. Such volatile fluids include carbon dioxide (CO₂), nitrogen (N₂) and hydrocarbons such as methane, ethane, propane, butane, liquefied natural gas (LNG), volatile crudes and condensates, and the like. These volatile fluids are often more completely recovered from the formation, because they are or become gaseous as pressure in the wellbore is relieved, and can cause less damage to the formation than water-based fluids.

Mixing of proppant and other additives with base fluids is typically carried out in a blender, and the resulting slurry is then pumped into the wellbore using high pressure pumps. Addition of proppant and other additives to base fluids with relatively low volatility or hazard, such as water, alcohols and hydrocarbons having a Reid vapour pressure of less than about 2 psi or less than about 14 kPa, can generally be safely and conveniently carried out in an open system under conditions in which the components are exposed to environmental temperatures and pressures. However, base fluids with a higher volatility, such as liquefied gases, must be handled under increased pressure and/or at reduced temperatures and in a closed system so as to remain liquid for injection into the wellbore. Additionally, base fluids such as concentrated acids are corrosive and can be hazardous, and contact of such fluids with unprotected personnel or equipment is desirably avoided. Therefore, adding proppant and additives to such base fluids can require specialized apparatus and techniques to prevent or control contact of the fluid with the environment.

Addition of proppant to highly volatile fracturing fluids can be carried out using blenders which are sealed from the environment. Such sealed blenders contain the proppant and the volatile fluid in a closed system so that the mixture is not exposed to the environment as it is blended to produce the slurry. However, operation may need to be stopped after production of each batch of slurry so that the blender can be refilled with additional proppant and fluid and re-sealed, and several such blenders may be required to operate concurrently or consecutively to produce slurry at the rate required to complete a fracturing job. Alternatively, dry solid proppant, or a stream of proppant-containing fluid can be added continuously or semi-continuously to a stream of a volatile or acidic base fluid to form the slurry, which is then pumped into a wellbore. Highly volatile or acidic fluids containing proppant, and/or methods and apparatus for preparing such fluids, are described in U.S. Pat. No. 4,126,181, in US patent application publications 2006/0243437, 2009/0183874, 2013/0255953, 2014/0151049, 2014/0151051, 2014/0174747, 2014/0299321, 2014/0374094, 2014/0378354, 2015/0157995, 2015/0204166 and 2015/0345269, and in Canadian patents or published applications 1,134,258, 2,198,156, 2,831,525, and 2,854,070.

However, new methods and apparatus for adding proppant to a base fluid, which allow continuous addition of the proppant, which permit contact of the fluid with the environment to be minimized or prevented, and which can, in some cases, advantageously increase safety and/or reduce costs, are desirable.

### SUMMARY

The present invention provides a method for preparing a proppant slurry for fracturing a subterranean formation, wherein the proppant slurry comprises a base fluid and a proppant. The method includes preparing a mixture comprising the proppant and a transfer fluid; and transferring the proppant from the mixture to the base fluid to form the proppant slurry. In at least one embodiment, the proppant is transferred from the mixture to the base fluid under the influence of gravity. In at least one embodiment, the base fluid and the proppant slurry are maintained in a closed system. In at least one embodiment, proppant is mixed with a transfer fluid to form a transfer slurry. The transfer slurry and the base fluid are introduced into a proppant exchange device, and the proppant is transferred from the transfer slurry to the base fluid to form the proppant slurry and a reclaimed transfer fluid. In at least one embodiment, the proppant is transferred to the base fluid as a concentrated slurry.

Another aspect of the present invention provides a proppant exchange device for use in the method as described herein. In at least one embodiment, the proppant exchange device is a proppant exchange chamber including a transfer slurry inlet for introduction of a transfer slurry into the proppant exchange chamber. In such embodiments, the transfer slurry includes a proppant and a transfer fluid, and the density of the proppant is greater than the density of the transfer fluid. In such embodiments, the proppant exchange chamber also includes a base fluid inlet for introduction of a base fluid into the proppant exchange chamber. In such embodiments, the density of the base fluid is greater than the density of the transfer fluid and the base fluid inlet is positioned below the transfer slurry inlet position. In such embodiments, when the transfer slurry is brought into direct contact with the base fluid in the proppant exchange chamber, the proppant is transferred from the transfer slurry to the base fluid under the influence of gravity to form a proppant slurry and a reclaimed transfer fluid. In such embodiments, the proppant exchange chamber also includes a proppant slurry outlet for removal of the proppant slurry from the proppant exchange chamber and a reclaimed transfer fluid outlet for removal of the reclaimed transfer fluid from the proppant exchange chamber.

In at least one alternative embodiment, the proppant exchange device includes a transfer slurry chamber, which includes a transfer slurry inlet for introduction of a transfer slurry into the transfer slurry chamber. In such alternative embodiments, the transfer slurry includes a proppant and a transfer fluid, and the transfer slurry separates within the transfer slurry chamber to form a concentrated slurry and a reclaimed transfer fluid. In such alternative embodiments, the transfer slurry chamber further includes a reclaimed transfer fluid outlet for removal of the reclaimed transfer fluid from the transfer slurry chamber. In addition, in such alternative embodiments, the proppant exchange device includes a base fluid chamber which includes a base fluid inlet for introduction of a base fluid into the base fluid chamber, and a proppant slurry outlet for removal of a proppant slurry from the base fluid chamber. In such alternative embodiments, the proppant exchange device further includes a proppant transfer device, which provides transfer of the concentrated slurry from the transfer slurry chamber to the base fluid chamber for mixing with the base fluid to form the proppant slurry.

### BRIEF DESCRIPTION OF THE DRAWINGS

Further features of the present invention will become apparent from the following written description and the accompanying figures, in which:

FIG. 1 is a schematic diagram of a work environment including an embodiment of apparatus for carrying out at least one embodiment of the method of the present invention;

FIG. 2 is a schematic flowchart representing at least one embodiment of the method of the present invention;

FIG. 3A is a schematic cross-sectional side view of one embodiment of a proppant exchange device according to the present invention;

FIG. 3B is a schematic cross-sectional end view of the embodiment of FIG. 3A taken along the line II-II;

FIG. 4 is a schematic cross-sectional side view of another embodiment of a proppant exchange device according to the present invention;

FIG. 5 is a schematic cross-sectional side view of yet another embodiment of a proppant exchange device according to the present invention; and

FIG. 6 is a schematic diagram of another embodiment of an apparatus for carrying out at least one embodiment of the method of the present invention.

### DEFINITIONS

As used herein, the term “in a closed system” with regard to a fluid or slurry described herein is intended to mean that the fluid or slurry is not exposed to the ambient conditions of the environment surrounding the closed system and that persons and objects in the immediate surroundings of the closed system are not in contact with, or exposed to, the fluid or slurry or its vapour. In at least one embodiment, a fluid or slurry which is in a closed system can be maintained under controlled conditions, including but not limited to temperature and/or pressure conditions which are different from the temperature and/or pressure conditions experienced in the environment surrounding the closed system. In at least one embodiment, there is minimal or substantially no transfer of mass between the fluid or slurry which is in the closed system and the surroundings of the closed system. In at least one embodiment, the closed system can be an isolated system so that there is minimal or substantially no transfer of mass or energy between the fluid or slurry which is in the closed system and the surroundings of the closed system.

As used herein, the term “immiscible”, in reference to fluids, is intended to refer to fluids which are substantially insoluble within each other such that they mix with each other to form a heterogeneous mixture, containing two or more distinct phases defining an interface therebetween. The distinct phases can be in the form of droplets of one fluid within a matrix of another fluid, or separate layers, for example. Each distinct phase of a mixture of immiscible fluids contains one of the fluids and substantially no or only a minimal concentration of the other fluid.

As used herein, the term “miscible”, in reference to fluids, is intended to refer to fluids which mix with each other to form a homogeneous mixture containing a single phase. As used herein, the term “partially miscible” is intended to refer to fluids which form a homogeneous mixture when mixed in some concentrations or proportions but form a heterogeneous mixture when mixed in other concentrations or proportions. For example, a first fluid can have a maximum solubility in a second fluid, such that when the concentration of the first fluid in the second fluid is lower than its maximum solubility, the fluids form a homogeneous mixture. However, when the concentration of the first fluid in the second fluid exceeds its maximum solubility, the excess of the first fluid can form a heterogeneous mixture with the saturated, homogeneous solution of the first fluid in the second fluid. Thus, at least one of the distinct phases of a heterogeneous mixture of partially miscible fluids can contain a measurable concentration of both fluids.

As used herein, the terms “about” and “approximately” are intended to refer to an acceptable degree of error for the quantity measured given the nature or precision of the measurements. For example, the degree of error can be indicated by the number of significant figures provided for the measurement, as is understood in the art, and includes but is not limited to a variation of ±1 in the most precise significant figure reported for the measurement. Typical exemplary degrees of error are within 10 percent (%), or within 5% of a given value or range of values. Numerical quantities given herein are approximate unless stated otherwise, meaning that the term “about” or “approximately” can be inferred when not expressly stated.

As used herein, the term “substantially” refers to the complete or nearly complete extent or degree of an action, characteristic, property, state, structure, item, or result. For example, “substantially all” of a substance would mean all or so nearly completely all of a substance that the difference is negligible or not measurable, and the effect is the same as if all of the substance were included. The exact allowable degree of deviation from absolute completeness can in some cases depend on the specific context. However, generally speaking, the nearness to completion will be so as to have the same overall result as if absolute and total completion were obtained.

The use of “substantially” is equally applicable when used in a negative connotation to refer to the complete or near complete lack of an action, characteristic, property, state, structure, item, or result. For example, “substantially no transfer” of mass or energy would mean no transfer, or so nearly complete a lack of transfer that the effect would be the same as if there were no transfer. In other words, there may be some minor transfer of mass or energy as long as the transfer does not produce a measurable or significant effect.

As used herein the term “minimal” is intended to mean a negligible or measurable but tolerable amount, or an amount for which compensation can be made without deleterious effect. For example, a minimal transfer of mass or energy during a process is a transfer of an amount of mass or energy that is negligible, or which has an effect on the process which is tolerable, or for which a user of the process can account or compensate without deleterious effect on the process.

As used herein, terms indicating relative vertical direction or orientation, including but not limited to “upper”, “lower”, “top”, “bottom”, “above”, “below”, “upwards”, “downwards” and the like, are words of convenience intended to indicate relative orientation or direction with respect to the earth's gravitational field in normal operation, and are not limiting terms. Thus, an object or substance has a tendency to move downwards from a position which is “upper”, “top”, or “above”, for example, to a position which is “lower”, “bottom” or “below”, for example, under the influence of the earth's gravitational field.

As used herein, the term “Reid vapour pressure” is intended to mean the vapor pressure at 37.8° C. (100° F.) of petroleum products and crude oils having an initial boiling point above 0° C. (32° F.), as measured by the method described in ASTM Standard D323 (Standard Test Method for Vapor Pressure of Petroleum Products (Reid Method)).

As used herein, the term “ambient environmental conditions” is intended to mean the conditions normally experienced by living humans on earth, including but not limited to external climatic conditions and conditions in sheltered spaces. Ambient environmental conditions include but are not limited to environmental air pressure and air temperature.

As used herein, the term “normal atmospheric pressure” is intended to mean the pressure exerted by the earth's atmosphere under conditions normally experienced on earth. On average, normal atmospheric pressure is approximately 1 atmosphere or 101.3 kPa, but can vary within limits well understood in the art, depending upon climatic conditions.

As used herein, the term “ambient temperature” is intended to mean the temperature of the air under ambient environmental conditions. Ambient temperature includes but is not limited to a range of about −40° C. to about 40° C.

### DETAILED DESCRIPTION

One aspect of the present invention is directed to a method for preparing a proppant slurry for fracturing a subterranean formation, wherein the proppant slurry comprises a base fluid and a proppant. In at least one embodiment, the base fluid can be selected from, but is not limited to, water, brine, hydrocarbons, alcohols, glycols, liquefied gases, liquid natural gas, acids, and combinations thereof. Suitable hydrocarbons include but are not limited to methane, ethane, propane, butane, isobutane, liquefied natural gas (LNG), volatile crudes and condensates, diesel and the like. The base fluid is desirably selected so as to be compatible with the formation to be treated, as is well understood in the art.

In at least one embodiment, the base fluid is a fluid which is desirably maintained in a closed system so as to protect workers or objects from contact with or exposure to the fluid or its vapours, or so as to provide controlled conditions for the fluid which are different from ambient environmental conditions. In at least one embodiment, the base fluid can be a liquid. In at least one embodiment, the base fluid can be a liquefied gas such as liquid CO₂, propane or butane, which, in order to remain liquid, requires maintenance under conditions of increased pressure and/or reduced temperature compared to the normal atmospheric pressure and ambient temperature. In at least one embodiment, the base fluid can be a volatile base fluid having a Reid vapour pressure greater than 14 kPa or greater than 2 psi. In at least one embodiment, the base fluid can be a noxious or corrosive base fluid, contact with or exposure to which can cause harm to workers or damage to machinery and other objects. In at least one embodiment, the noxious or corrosive base fluid can be an acid, including but not limited to hydrochloric acid (HCl) or hydrofluoric acid (HF) and mixtures thereof.

In at least one embodiment, the proppant is sand, bauxite, sintered bauxite or ceramic particles, such as are well known in the art. The proppant can be selected for size, shape, porosity, crush resistance, chemical treatment, including but not limited to surface treatment, and other properties as required by the needs of the particular application or job, as known in the art.

The base fluid and/or proppant slurry can contain one or more other additives and components known in the art, including but not limited to viscosifiers, gelling agents, crosslinkers, breakers, friction reducers, fluid loss additives, surfactants, emulsifiers, demulsifiers, clay control agents, corrosion inhibitors, scale inhibitors, pH control agents, biocidal agents and co-solvents. Such additives can be added either to the base fluid prior to formation of the proppant slurry, or to the proppant slurry after it is formed. In at least one embodiment, the one or more additives are added to the proppant slurry after it is formed.

The method includes mixing the proppant with a transfer fluid to form a mixture. In at least one embodiment, the transfer fluid is selected so as to carry out at least one of the following functions:
to coat and/or be absorbed by the proppant, including but not limited to purging gases from pores and crevices in the bulk proppant;
to adjust the conditions of the proppant, including but not limited to temperature, in preparation for addition to the base fluid;
to be an additive to the base fluid;
to transport proppant to a site or device for transfer to the base fluid; and
to provide a seal or barrier between the base fluid and the surrounding environment during proppant transfer.

In at least one embodiment, the transfer fluid can be selected from, but is not limited to, water, brine, hydrocarbons, alcohols, glycols, liquefied gases, liquid natural gas, acids, and combinations thereof. In at least one embodiment, the transfer fluid is a hydrocarbon having a Reid vapour pressure of less than about 14 kPa or less than about 2 psi, including but not limited to refined oil, diesel fuel, mineral oil, and gas condensate. In at least one alternative embodiment, the transfer fluid is chosen from water, brine, glycols, methanol and mixtures thereof. Water-based transfer fluids can contain dissolved salts including but not limited to potassium chloride (KCl).

In at least one embodiment, the transfer fluid is a different fluid from the base fluid. In at least one embodiment, the transfer fluid is substantially immiscible with the base fluid. In at least one embodiment, the transfer fluid is at least partially miscible with the base fluid. In at least one embodiment, the transfer fluid has a density which is less than the density of the base fluid. In at least one embodiment, the transfer fluid has a density which is greater than the density of the base fluid.

In at least one embodiment, the transfer fluid contains one or more other additives known in the art, including but not limited to breakers, friction reducers, fluid loss additives, surfactants, emulsifiers, demulsifiers, flow enhancers, activators and leak-off additives. In at least one embodiment, the transfer fluid contains one or more surfactants. Suitable surfactants are known in the art and include, but are not limited to non-ionic surfactants, cationic surfactants, anionic surfactants and zwitterionic surfactants.

In at least one embodiment, the proppant is mixed with the transfer fluid using a blender. In at least one embodiment, the proppant is added continuously to the blender using a conveyer or augur, as well known in the art. In at least one embodiment, the proppant is stored at the ambient temperature of the environment prior to addition to the transfer fluid. In at least one embodiment, the temperature of the proppant can be adjusted, prior to or during mixing with the transfer fluid, to be about equal to the temperature of the transfer fluid with which it is to be mixed. Thus, when the temperature of the transfer fluid is lower than the temperature at which the proppant is stored, the proppant can be cooled to about the temperature of the transfer fluid prior to or during mixing with the transfer fluid in the blender. In at least one embodiment, the transfer fluid is adjusted to the desired temperature using methods known in the art, and the temperature-adjusted transfer fluid acts to adjust the temperature of the proppant to the desired temperature as the transfer fluid and proppant are mixed.

In at least one embodiment, the mixture of proppant and transfer fluid in the blender is exposed to the environment. An environmentally exposed blender can be used to mix proppant with transfer fluids which are not hazardous to workers or operations or to the environment, or which have a low volatility, having a Reid vapour pressure of less than about 14 kPa or less than about 2 psi. In at least one embodiment, the mixture of proppant and transfer fluid in the blender is sealed from exposure to the environment. An environmentally sealed blender can be used to mix proppant with transfer fluids which are hazardous to workers or operations or to the environment, or which are volatile, having a Reid vapour pressure of greater than about 14 kPa or greater than about 2 psi. If proppant is to be mixed with a transfer fluid which is very volatile, including but not limited to liquefied gases or fluids having a Reid vapour pressure of greater than about 69 kPa or greater than about 10 psi, an environmentally sealed batch blender can be used. Such an environmentally sealed batch blender will allow the proppant and transfer fluid to be blended under conditions of pressure greater than ambient atmospheric pressure. Thus, the mixture of proppant and transfer fluid in an environmentally sealed blender or an environmentally sealed batch blender can be maintained under conditions of temperature and/or pressure which are different from the ambient environmental conditions of temperature and pressure.

The method further includes transferring the proppant from the mixture to the base fluid to form the proppant slurry. In at least one embodiment, a concentrated slurry is formed from the mixture of proppant and transfer fluid. In embodiments in which the density of the proppant is greater than the density of the transfer fluid, the proppant can settle under the influence of gravity to form the concentrated slurry. In at least one embodiment, the concentrated slurry can be formed from the mixture of proppant and transfer fluid by centrifugation, using techniques and apparatus well known in the art.

In at least one embodiment, the concentrated slurry is transferred to the base fluid using a proppant transfer device. In at least one embodiment, the proppant transfer device includes a valve to prevent or allow the entry of the concentrated slurry into the base fluid and/or to control the rate at which the concentrated slurry is added to the base fluid. In at least one embodiment, the proppant transfer device further includes a one-way valve to prevent base fluid from flowing back through the valve as the concentrated slurry is transferred to the base fluid. In at least one embodiment, the one-way valve can be a variable orifice three-phase one-way valve, of the type including but not limited to a duckbill valve (Minivalve International BV). Other suitable one-way valves are known to the skilled person.

Embodiments of the proppant transfer device can also include a proppant moving device, including but not limited to an augur, a bulk solids pump, a positive displacement solid feed device or other devices known in the art for transferring solids. For example, solid feed devices sold under the trademark Posimetric™ (GE Energy (USA) LLC) are described at least in US patent application publications 2014/0151049, 2014/0299321 and 2015/0204166.

It will be apparent to the skilled person that the concentrated slurry being transferred to the base fluid will contain a small amount of transfer fluid included in the pores of the proppant or between the particles of proppant. Therefore, as discussed in further detail below, a small amount of transfer fluid, and any additives contained therein, can become part of the proppant slurry. Thus, in one or more embodiments of the present method, additives which are intended to be present in the proppant slurry can be included in the transfer fluid.

In at least one embodiment, the transfer fluid and proppant are mixed to form a transfer slurry. In such embodiments, the method further includes introducing the transfer slurry and the base fluid into a proppant exchange device. In at least one embodiment, the transfer slurry enters the proppant exchange device through a transfer slurry inlet. In at least one embodiment, the base fluid enters the proppant exchange device through a base fluid inlet.

In at least one embodiment, including but not limited to embodiments in which the base fluid is a liquefied gas maintained under conditions of increased pressure and/or reduced temperature compared to the normal atmospheric pressure and ambient temperature, the pressure and/or temperature of the transfer slurry can be adjusted to be similar to those of the base fluid, using methods well known in the art. For example, the temperature of the transfer slurry can be reduced by well-known refrigeration techniques, including but not limited to heat exchangers and expansion of pressurized or liquefied gases. Such adjustment of conditions can take place during mixing of the transfer slurry in the blender, or before or during transport of the transfer slurry to the proppant exchange chamber, for example. In at least one embodiment, the transfer fluid is adjusted to the desired temperature using methods known in the art, and the temperature-adjusted transfer fluid acts to adjust the temperature of the proppant and the resulting transfer slurry to the desired temperature as the transfer fluid and proppant are mixed. In at least one embodiment, the pressure of the transfer slurry is adjusted to be about equal to the pressure of the base fluid. In at least one embodiment, the pressure of the transfer slurry is adjusted to be higher than the pressure of the base fluid. In at least one embodiment, the temperature of the transfer slurry is adjusted to be about equal to the temperature of the base fluid. In this way, vaporization of the base fluid caused by contact with a transfer slurry at a higher temperature than the temperature of the base fluid can be advantageously avoided. As is appreciated by the skilled person, vaporization of the base fluid can undesirably cause cavitation or loss of prime in high pressure pumps pumping the base fluid stream or proppant slurry stream.

In at least one embodiment, the proppant exchange device includes a proppant exchange chamber, in which the transfer slurry is brought into direct contact with the base fluid so that proppant can be directly transferred from the transfer slurry to the base fluid. In at least one such embodiment, the transfer slurry and the base fluid can enter the proppant exchange chamber such that the transfer slurry stream and the base fluid stream flow in parallel and in the same general horizontal direction.

In at least one embodiment, the transfer fluid has a density which is lower than the density of the base fluid. In at least one such embodiment, the transfer slurry inlet can be positioned above the base fluid inlet, such that the transfer slurry is introduced into the proppant exchange chamber at a position which is above the position at which the base fluid enters the proppant exchange chamber. In at least one embodiment, the proppant has a higher density than the density of the transfer fluid. In at least one such embodiment, the proppant can separate from, or settle out of, the transfer slurry under the influence of gravity, once the transfer slurry has entered the proppant exchange chamber, and the proppant can move downwards and be transferred into the base fluid to form the proppant slurry. Thus, as proppant is transferred from the transfer slurry to the base fluid, the less dense reclaimed transfer fluid will float above the more dense base fluid. In at least one embodiment, the proppant also has a higher density than the density of the base fluid. In such embodiments, the proppant can also settle through the base fluid and accumulate, such that the proppant slurry can be more concentrated towards the bottom of the proppant exchange chamber.

In at least one embodiment, the cross-sectional area of the proppant exchange chamber is greater than the cross-sectional area of the transfer slurry inlet, so that the cross-sectional flow rate (m/min) of the transfer slurry decreases as the transfer slurry enters the proppant exchange chamber. In such embodiments, the settling out of the proppant from the transfer slurry is facilitated by the decrease of the cross-sectional flow rate of the transfer slurry as the transfer slurry enters the proppant exchange device. In at least one such embodiment, the proppant exchange chamber defines a transfer zone between the position of the transfer slurry inlet and the position of the base fluid inlet. In such a transfer zone, the cross-sectional flow rates of the transfer slurry and the base fluid are minimal or substantially reduced to zero so that the transfer slurry and base fluid are substantially stationary, and the transfer slurry is in direct contact with the base fluid.

In embodiments in which the transfer fluid is substantially immiscible with the base fluid, minimal or substantially no mixing will occur between the transfer fluid or transfer slurry and the base fluid within the transfer zone. In such embodiments, a defined interface can exist in the transfer zone between the transfer fluid or transfer slurry and the base fluid. However, in embodiments in which the transfer fluid is at least partially miscible with the base fluid, at least partial mixing can occur between the transfer fluid or transfer slurry and the base fluid within the transfer zone, to provide a concentration gradient in which the composition of the fluid component (i.e. excluding the proppant) of the contents of the proppant exchange chamber can vary from substantially 100% transfer fluid at the transfer slurry inlet to substantially 100% base fluid at the base fluid inlet. In such embodiments, a defined interface may or may not exist in the transfer zone between the transfer fluid or transfer slurry and the base fluid. In addition, as the proppant is transferred through the transfer zone from the transfer slurry to the base fluid to form the proppant slurry, transfer fluid in contact with the proppant can be exchanged for base fluid, and further mixing of transfer fluid and base fluid can occur. Thus, depending on the specific conditions within the transfer zone, as understood in the art, varying amounts of transfer fluid and any additives included therein can be mixed with the proppant and base fluid in the proppant slurry. Thus, in at least one embodiment, a measurable amount of transfer fluid is mixed with the proppant and base fluid in the proppant slurry. In at least one alternative embodiment, substantially no transfer fluid is mixed with the proppant and base fluid in the proppant slurry.

It may be desirable to exclude transfer fluid as far as possible from the proppant slurry, or to include a particular concentration of transfer fluid within the proppant slurry, depending upon the needs of the application or job. Therefore, as will be understood by those skilled in the art, the specific conditions within the transfer zone, including but not limited to the mutual miscibility of the transfer slurry and base fluid, the relative entrance flow rates of the transfer slurry and base fluid, the relative exit flow rates of the proppant slurry and the reclaimed transfer fluid, and the dimensions of the transfer zone, can be adjusted to increase or decrease the amount of transfer fluid contained in the proppant slurry as desired. In at least one embodiment, one or more conditions within the transfer zone are controlled such that the proppant slurry contains substantially no transfer fluid. In at least one embodiment, one or more conditions within the transfer zone are controlled such that the proppant slurry contains a predetermined concentration of transfer fluid. It is also envisioned that one or more of the conditions within the transfer zone can be changed during the preparation of the proppant slurry, such that the composition of the proppant slurry changes during a particular fracturing job.

In at least one alternative embodiment, the proppant exchange device includes a transfer slurry chamber having a transfer slurry inlet and a reclaimed transfer fluid outlet. The transfer slurry is introduced into the transfer slurry chamber through the transfer slurry inlet and the transfer slurry separates within the transfer slurry chamber to provide a concentrated slurry and a reclaimed transfer fluid. In embodiments in which the density of the proppant is greater than the density of the transfer fluid, the proppant can settle towards the bottom of the transfer slurry chamber under the influence of gravity to form the concentrated slurry. In at least one embodiment, the transfer slurry chamber can include baffles to minimize agitation of the transfer slurry and promote settling of the proppant to form the concentrated slurry. In at least one embodiment, the concentrated slurry and the reclaimed transfer fluid can be formed from the transfer slurry by centrifugation, using techniques and apparatus well known in the art. In at least one embodiment, the reclaimed transfer fluid outlet can be advantageously positioned above the transfer slurry inlet, so that the reclaimed transfer fluid exiting the proppant exchange chamber contains substantially no proppant or a minimal amount of proppant, and substantially all or most of the proppant in the transfer slurry is in the concentrated slurry.

In such alternative embodiments, the proppant exchange device further includes a base fluid chamber having a base fluid inlet and a proppant slurry outlet. In at least one embodiment, the base fluid chamber can be a conduit or chamber through which a stream of base fluid is flowing. In at least one embodiment, the base fluid chamber can be a blender, including but not limited to a centrifugal blender, a tub blender or a sealed blender. In at least one embodiment, the base fluid is a liquefied gas maintained under conditions of increased pressure and/or reduced temperature compared to the normal atmospheric pressure and ambient temperature, and the base fluid chamber is part of a closed system. In such embodiments, the pressure and/or temperature of the transfer slurry in the transfer slurry chamber can be adjusted to be similar to those of the base fluid in the base fluid chamber, as discussed above. In at least one embodiment, the pressure of the transfer slurry is adjusted to be about equal to the pressure of the base fluid. In at least one embodiment, the pressure of the transfer slurry is adjusted to be higher than the pressure of the base fluid. In at least one embodiment, the temperature of the transfer slurry is adjusted to be about equal to the temperature of the base fluid.

In such alternative embodiments, the proppant exchange device still further includes a proppant transfer device as described above to provide transfer of the concentrated slurry from the transfer slurry chamber to the base fluid chamber. In at least one embodiment, the base fluid chamber is positioned below the transfer slurry chamber so that the concentrated slurry can be transferred with the aid of gravity from the transfer slurry chamber to the base fluid chamber through the proppant transfer device. However, it is contemplated that in other embodiments, the base fluid chamber can be positioned in other orientations, including but not limited to above or to the side of the transfer slurry chamber, as long as the concentrated slurry can be transferred to the base fluid chamber by the proppant transfer device. In at least one embodiment, the base fluid chamber includes baffles in the vicinity of the proppant transfer device to prevent agitation as the concentrated slurry enters the base fluid. In embodiments in which the proppant has a higher density than the density of the base fluid, the concentrated slurry transferred through the proppant transfer device can settle through the base fluid to form the proppant slurry towards the bottom of the base fluid chamber. In such embodiments, the proppant slurry outlet is advantageously positioned towards the bottom of the base fluid chamber. Such embodiments of the base fluid chamber can further include a purge line to aid in the initial filling of the base fluid chamber with base fluid.

In at least one embodiment, the transfer fluid has a lower density than the density of the base fluid, and the transfer fluid and base fluid are substantially immiscible with each other. In such embodiments, as the concentrated slurry enters the base fluid chamber and becomes mixed with the base fluid, any transfer fluid remaining within pores or crevices in the proppant or between particles of proppant within the concentrated slurry can be exchanged for base fluid, and can collect in the upper part of the base fluid chamber, due to its lower density compared to the base fluid. In such embodiments, the proppant exchange device can further include a return line through which collected transfer fluid can be returned to the transfer slurry chamber or recovered as reclaimed transfer fluid.

In at least one embodiment, the proppant slurry is pumped out of the proppant exchange device through a proppant slurry outlet and injected into a formation at a flow rate and pressure required to fracture the formation, as is understood by the skilled person. In at least one embodiment, the proppant slurry is pumped out of the proppant exchange device through the proppant slurry outlet with one or more high pressure pumps, as well known in the art. Thus, in at least one embodiment, the pressure of the proppant slurry within the proppant exchange device, and initially exiting the proppant exchange device through the proppant slurry outlet, is considerably less than the pressure of the proppant slurry stream exiting the high pressure pump for injection into the formation at the wellhead. For example, in at least one embodiment, the pressure of the proppant slurry within the proppant exchange device and exiting the proppant exchange device through the proppant slurry outlet is no greater than about 500 psi or no greater than about 3.5 MPa. In at least one embodiment, the pressure of the proppant slurry within the proppant exchange device and exiting the proppant exchange device through the proppant slurry outlet is from about 10 psi to about 500 psi or about 70 kPa to about 3.5 MPa. In at least one embodiment, the pressure of the proppant slurry within the proppant exchange device and exiting the proppant exchange device through the proppant slurry outlet is from about 350 psi to about 400 psi or about 2 MPa to about 3 MPa. In at least one embodiment, the pressure of the proppant slurry within the proppant exchange device and exiting the proppant exchange device through the proppant slurry outlet is from about 10 psi to about 300 psi or about 70 kPa to about 2 MPa. In at least one embodiment, the pressure of the proppant slurry within the proppant exchange device and exiting the proppant exchange device through the proppant slurry outlet is ambient atmospheric pressure. In contrast, in at least one embodiment the pressure of the proppant slurry stream exiting the high pressure pump and being injected into the formation is not less than about 2000 psi or not less than about 13.5 MPa. In at least one embodiment the pressure of the proppant slurry stream exiting the high pressure pump and being injected into the formation is from about 2000 psi to about 15,000 psi, or from about 13.5 MPa to about 105 MPa.

In such embodiments, the base fluid is pumped into the proppant exchange device at a flow rate and pressure required to maintain the desired flow rate and pressure of the proppant slurry exiting the proppant slurry outlet. In at least one embodiment, the transfer slurry is pumped into the proppant exchange device through the transfer slurry inlet at a flow rate which will provide proppant to the base fluid at a sufficient rate to support the production of proppant slurry at the desired flow rate and proppant concentration to be injected into and fracture the formation.

The proppant slurry can be further treated, including but not limited to undergoing addition of further additives, before it enters the formation. In at least one embodiment, additives can be added to the proppant slurry prior to entry of the proppant slurry into the one or more high pressure pumps. In at least one embodiment, additives can be added to the proppant slurry stream exiting the one or more high pressure pumps. Examples of additives advantageously added to the proppant slurry stream exiting the one or more high pressure pumps include but are not limited to gaseous additives including but not limited to nitrogen gas.

In at least one embodiment, the reclaimed transfer fluid, which remains as the proppant is transferred from the transfer slurry, exits the proppant exchange device through a reclaimed transfer fluid outlet. In at least one embodiment, flow of the reclaimed transfer fluid from the proppant exchange device through the reclaimed transfer fluid outlet is controlled by a choke valve, so that the pressure exerted by the transfer slurry and transfer fluid is equal to or greater than the pressure exerted by the base fluid and proppant slurry. In at least one embodiment, the reclaimed transfer fluid outlet is positioned level with the transfer slurry inlet. In at least one embodiment, the reclaimed transfer fluid outlet is positioned above the transfer slurry inlet, so that the reclaimed transfer fluid exiting the proppant exchange chamber contains a minimal amount of proppant. The reclaimed transfer fluid can be further purified if necessary, and recovered, for use in the production of additional transfer slurry, for example. In at least one embodiment, before recovery, the reclaimed transfer fluid can be passed through a separator to separate any remaining proppant, as well as any gaseous contaminants, which can be vented to the atmosphere or flared.

The present method can have one or more advantages over known methods of adding proppant to a base fluid maintained in a closed system. The present method can provide substantially continuous addition of proppant to the base fluid, while protecting the base fluid from contact with the environment, even when the base fluid is at a reduced temperature and/or an increased pressure compared to the environmental conditions under which the proppant is stored prior to addition. The presence of the mixture of proppant and transfer fluid or transfer slurry can act to provide a seal or barrier between the base fluid and the surrounding environment, so as to protect workers or objects from contact with or exposure to the base fluid or its vapours, or so as to protect the base fluid from exposure to ambient environmental conditions of temperature or pressure, for example. This avoids the need for a batch blending process, in which the proppant and base fluid must be added to a blender under the reduced temperature and/or increased pressure conditions, and which can produce only a limited batch of slurry at a time. However, it is envisioned that the proppant can be added to the transfer fluid to produce the mixture or transfer slurry using such a batch blending process, as long as the mixture or transfer slurry is produced at a rate adequate to provide proppant to the base fluid in a substantially continuous process.

In addition, prior known methods of adding a proppant-containing slurry stream into a base fluid stream require that all the fluid within the proppant-containing slurry stream is added to and mixed with the base fluid stream. In contrast, the present method can minimize or control the amount of the transfer fluid added to the base fluid. For example, in embodiments of the present method, the proppant is allowed to settle away from the transfer fluid in the transfer slurry through a transfer zone, as previously described, before introduction into a base fluid stream which is in direct contact with the transfer slurry. Thus, in such embodiments, transfer fluid in contact with the proppant can be exchanged for base fluid to a desired extent as the proppant settles from the transfer slurry into the base fluid through the transfer zone, and the concentration of transfer fluid, and any additives included therein, in the proppant slurry is controlled.

In alternative embodiments of the present method, a concentrated slurry is added to the base fluid. Thus, only the small amount of transfer fluid which is included in the pores of the proppant or between the particles of proppant in the concentrated slurry is carried into the base fluid. Furthermore, as described above, in embodiments in which the transfer fluid and base fluid are immiscible with each other, part or even substantially all of the small amount of transfer fluid in contact with the proppant in the concentrated slurry can be exchanged for base fluid and collected as a separate layer as the concentrated slurry is mixed with the base fluid. The collected transfer fluid can be reclaimed as previously described. In this way, the composition of the base fluid stream is better controlled, and the bulk of the transfer fluid can be re-used to transfer further proppant, providing cost savings.

### DESCRIPTION OF SPECIFIC EMBODIMENTS

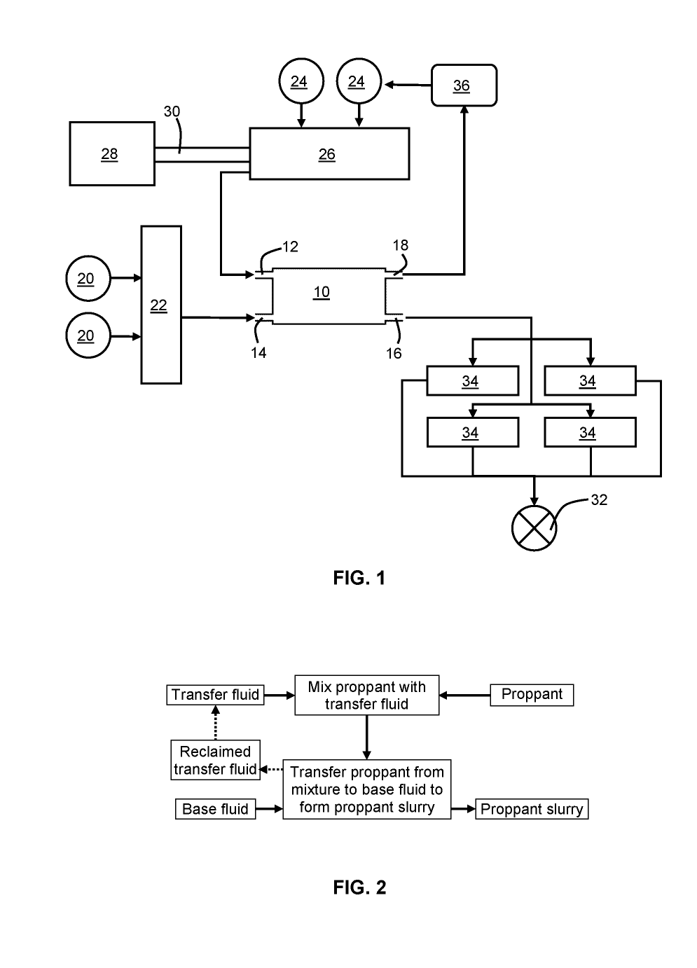

Specific embodiments of the present method are now described with reference to the figures, in which like reference characters represent like elements. With reference to FIGS. 1 and 2, proppant exchange device 10 has transfer slurry inlet 12, base fluid inlet 14, proppant slurry outlet 16 and reclaimed transfer fluid outlet 18. Base fluid is supplied from a base fluid storage vessels 20 to pump 22, and then pumped to base fluid inlet 14. Transfer fluid is stored in transfer fluid storage vessels 24, and is provided to mixing point 26 where the proppant and transfer fluid are mixed to form a transfer slurry. Proppant 28 is transferred to mixing point 26 by means of proppant transfer system 30, which can be a conveyer belt, an augur, a spout, or any other means of conveying proppant well known in the art. Mixing point 26 can be any device known in the art for mixing proppant with a carrier fluid, including but not limited to a blender which may be exposed to the environment or sealed. In at least one embodiment, the temperature and/or pressure of either or both of the transfer fluid and proppant can be adjusted, before, during or after mixing of the proppant and the transfer fluid at mixing point 26.

The transfer slurry is then pumped into proppant exchange device 10 from mixing point 26 through transfer slurry inlet 12. Proppant 28 is transferred from the transfer slurry to the base fluid to form a proppant slurry and a reclaimed transfer fluid as described in further detail herein. The proppant slurry is removed from the proppant exchange device 10 at proppant slurry outlet 16, and pumped to a wellhead indicated at 32 by means of high pressure pumps 34. The reclaimed transfer fluid is collected at reclaimed transfer fluid outlet 18 and can be returned to a transfer fluid storage vessel 24 for reuse in preparing further transfer slurry. A choke valve (not shown) can control the pressure of the transfer slurry and transfer fluid within proppant exchange device 10. The reclaimed transfer fluid can be further treated before being returned to a transfer fluid storage vessel 24, by, in at least one embodiment, passing through a separator 36, which further separates the reclaimed transfer fluid from any remaining proppant or other contaminants. In at least one embodiment, any volatile contaminants separated from the transfer fluid can be disposed of by flaring or venting to the atmosphere, as is well known in the art.

It is contemplated that the fluid storage vessel 24 to which the reclaimed transfer fluid is returned is the same fluid storage vessel 24 from which the transfer fluid was originally obtained for transfer to blender 26, to mix with any remaining unused transfer fluid. Alternatively, it is contemplated that the reclaimed transfer fluid can be returned to a separate fluid storage vessel 24, so as to avoid contamination of unused transfer fluid with reclaimed transfer fluid. It is also contemplated that either new transfer fluid or reclaimed transfer fluid, or a mixture of both can be transferred to blender 26 for addition of proppant in the preparation of transfer slurry.

Although FIG. 1 shows a certain number of each of proppant exchange device 10, base fluid storage vessel 20, transfer fluid storage vessel 24, proppant transfer system 30, pumps 22 or 34, mixing point 26 or wellhead 32, it will be understood by those skilled in the art, that the present method can be carried out with any number of any or all of these devices or systems, as required for a particular application.

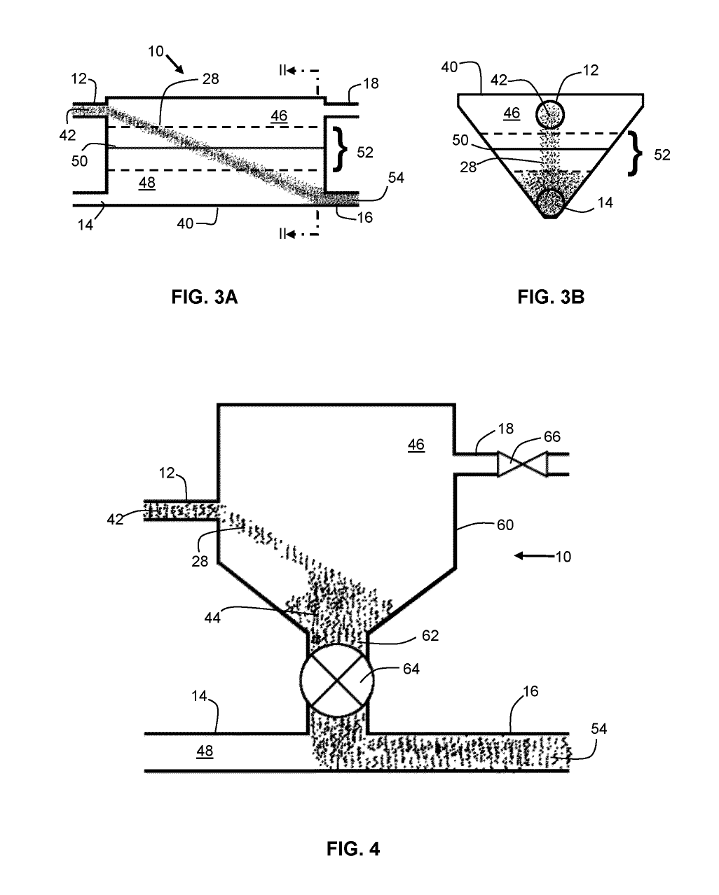

One embodiment of the proppant exchange device 10 includes a proppant exchange chamber 40, illustrated in FIGS. 3A and 3B. As better seen in FIG. 3B, the width of proppant exchange chamber 40 is greatest at its uppermost portion, and the width decreases therefrom towards the lowermost portion of proppant exchange chamber 40. Thus, the cross-sectional area of proppant exchange chamber 40 is greater near transfer slurry inlet 12 and is smaller near base fluid inlet 14.

In operation, transfer slurry 42, containing proppant 28 and transfer fluid 46, is pumped into proppant exchange chamber 40 through transfer slurry inlet 12. Because the cross-sectional area of proppant exchange chamber 40 is greater than the cross-sectional area of transfer slurry inlet 12, the cross-sectional rate of flow of transfer slurry 42 can decrease as it passes from transfer slurry inlet 12 into proppant exchange chamber 40. In addition, base fluid 48 is pumped into proppant exchange chamber 40 through base fluid inlet 14.

Interface 50 or transfer zone 52 is formed where transfer slurry 42 or transfer fluid 46 contacts base fluid 48, depending upon the relative miscibility of transfer fluid 46 and base fluid 48, as previously discussed. In the illustrated embodiment, proppant 28 has a higher density than both transfer fluid 46 and base fluid 48, and therefore begins to settle out of transfer slurry 42 as the cross-sectional flow rate decreases and transfer slurry 42 becomes more stationary. Thus, proppant 28 falls under the influence of gravity from transfer fluid 46 in the upper portion of proppant exchange chamber 40, through fluid interface 50 or transfer zone 52, into base fluid 48, and is concentrated in the lower portion of proppant exchange chamber 40, thereby forming proppant slurry 54. Proppant slurry 54 is then pumped out of proppant slurry outlet 16 and to the wellhead, as described above. Reclaimed transfer fluid 46, which is now depleted of proppant, can be recovered through reclaimed transfer fluid outlet 18, and reused in the preparation of further transfer slurry.

When base fluid 48 is maintained at a reduced temperature and/or an increased pressure compared to the surrounding environment, it is advantageous for transfer slurry 42 and reclaimed transfer fluid 46 to be kept under comparable conditions of reduced temperature and/or increased pressure while in contact with the base fluid and the proppant slurry formed therefrom. Therefore, a choke valve (not shown) acts to maintain the required pressure on reclaimed transfer fluid 46 until it exits proppant exchange chamber 40 at reclaimed transfer fluid outlet 18 and is recovered for reuse.

FIG. 4 illustrates another embodiment of the proppant exchange device 10. Transfer slurry chamber 60 receives transfer slurry 42 containing proppant 28 and transfer fluid 46 through transfer slurry inlet 12. A throat 62, controlled by proppant transfer device 64, provides fluid communication between transfer slurry chamber 60 and a stream of base fluid 48 entering at base fluid inlet 14. Proppant transfer device 64 can include a valve to control passage of material between transfer slurry chamber 60 and the stream of base fluid 48. Proppant transfer device 64 can also include a one-way valve, including but not limited to a variable orifice three-phase one-way valve or a duckbill valve (Minivalve International BV), to prevent backflow of base fluid 48 to transfer slurry chamber 60. Proppant transfer device 64 can also include a proppant moving device, including but not limited to an augur, bulk solids pump, positive displacement solid feed device, or other device known in the art.

In operation, transfer slurry 42 is pumped into transfer slurry chamber 60 through transfer slurry inlet 12. In the present embodiment, proppant 28 has a higher density than transfer fluid 46, and transfer slurry 42 separates under the influence of gravity to form reclaimed transfer fluid 46 and concentrated slurry 44, which collects at throat 62 at the bottom of transfer slurry chamber 60. Reclaimed transfer fluid 46 can be returned to a transfer fluid storage vessel 24 through reclaimed transfer fluid outlet 18, as previously described. A choke valve 66 can act to maintain any required pressure on transfer slurry 42 and reclaimed transfer fluid 46. Opening or activation of proppant transfer device 64 allows concentrated slurry 44 to be transferred from transfer slurry chamber 60 to the stream of base fluid 48. The stream of base fluid 48 entering at base fluid inlet 14 can mix with the concentrated slurry 44 to form a stream of proppant slurry 54 being pumped to the wellhead through proppant slurry outlet 16.

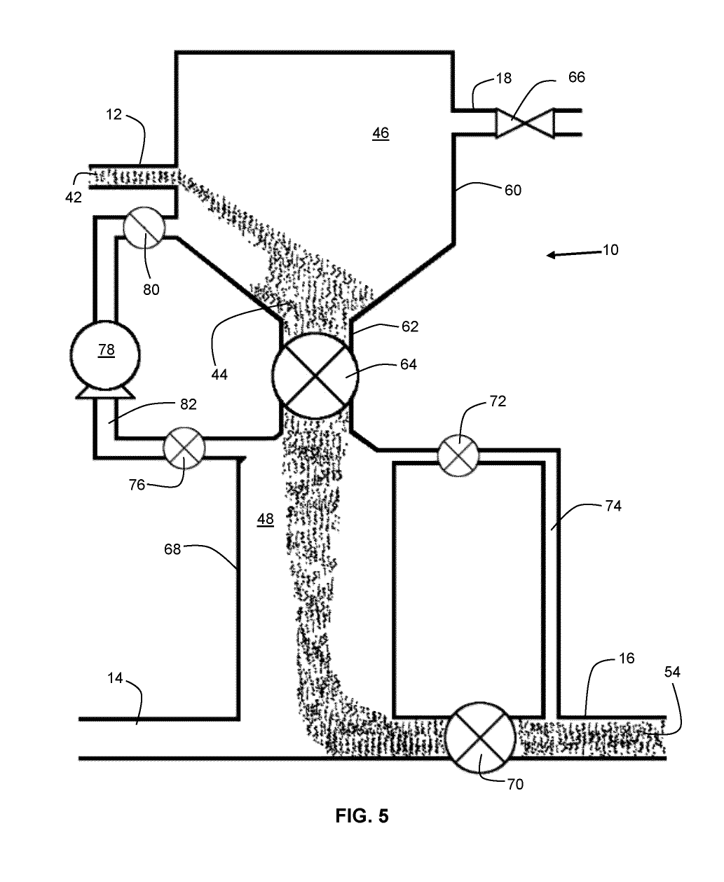

FIG. 5 illustrates another embodiment of the proppant exchange device 10, including transfer slurry chamber 60, similar to that shown in FIG. 4, and base fluid chamber 68. Transfer slurry chamber 60 receives transfer slurry 42 through transfer slurry inlet 12, and base fluid chamber 62 accepts base fluid 48 through base fluid inlet 14. Valve 70 controls fluid communication between base fluid chamber 68 and proppant slurry outlet 16. Valve 72 controls fluid communication between base fluid chamber 68 and purge line 74. Valve 76, pump 78 and one-way check valve 80 control fluid communication between base fluid chamber 68 and transfer slurry chamber 60 through return line 82.

Throat 62 provides fluid communication between transfer slurry chamber 60 and base fluid chamber 68, controlled by proppant transfer device 64. Proppant transfer device 64 can include a valve to control passage of concentrated slurry 44 from transfer slurry chamber 60 into base fluid chamber 68. Proppant transfer device 64 can also include a one-way valve, including but not limited to a variable orifice three-phase one-way valve or a duckbill valve (Minivalve International BV), to prevent base fluid 48 from flowing back from base fluid chamber 68 to transfer slurry chamber 60. Proppant transfer device 64 can also or alternatively include a proppant moving device, including but not limited to an augur, bulk solids pump, positive displacement solid feed device, or other device known in the art.

In operation, transfer slurry 42 is pumped into transfer slurry chamber 60 through transfer slurry inlet 12 and transfer slurry 42 separates to form concentrated slurry 44 and reclaimed transfer fluid 46. Concentrated slurry 44 collects at throat 62 at the bottom of transfer slurry chamber 60. Reclaimed transfer fluid 46 can be returned to a transfer fluid storage vessel 24 through reclaimed transfer fluid outlet 18, controlled by choke valve 66.

Base fluid 48 is pumped into base fluid chamber 68 through base fluid inlet 14. Closure of valve 70 and opening of valve 72 allows base fluid 48 to fill base fluid chamber 68 and pass into proppant slurry outlet 16 through purge line 74. Once base fluid chamber has been filled with base fluid 48, valve 72 can be closed and valve 70 opened, so that base fluid 48 can pass directly through proppant slurry outlet 16 to high pressure pumps 34, as seen in FIG. 1.

Opening or activation of proppant transfer device 64 allows concentrated slurry 44 to be transferred from transfer slurry chamber 60 to base fluid chamber 68. Because the proppant has a higher density than base fluid 48 in the illustrated embodiment, the concentrated slurry 44 falls to the bottom of base fluid chamber 68, where the stream of base fluid 48 entering base fluid chamber 68 at base fluid inlet 14 can mix with the concentrated slurry 44 to form a stream of proppant slurry 54 being pumped to the wellhead through proppant slurry outlet 16.

The concentrated slurry 44 in throat 62 carries a minimal amount of transfer fluid 46 into base fluid 48. As the concentrated slurry 44 passes through base fluid 48 to the bottom of base fluid chamber 68, some or all of the remaining transfer fluid 46 within the pores of the proppant can be exchanged for base fluid 48. If transfer fluid 46 is less dense than, and substantially immiscible with, base fluid 48, the exchanged transfer fluid 46 can rise to the top of base fluid chamber 68 and collect near throat 62. The collected transfer fluid 46 can be pumped back to transfer slurry chamber 60 through return line 82, using pump 78, by opening valve 76. Alternatively, the collected transfer fluid 46 can be can be returned to separator 36 or to a transfer fluid storage vessel 24, as previously described. One-way check valve 80 prevents transfer fluid 46 or transfer slurry 42 from flowing back through return line 82 into base fluid chamber 68.

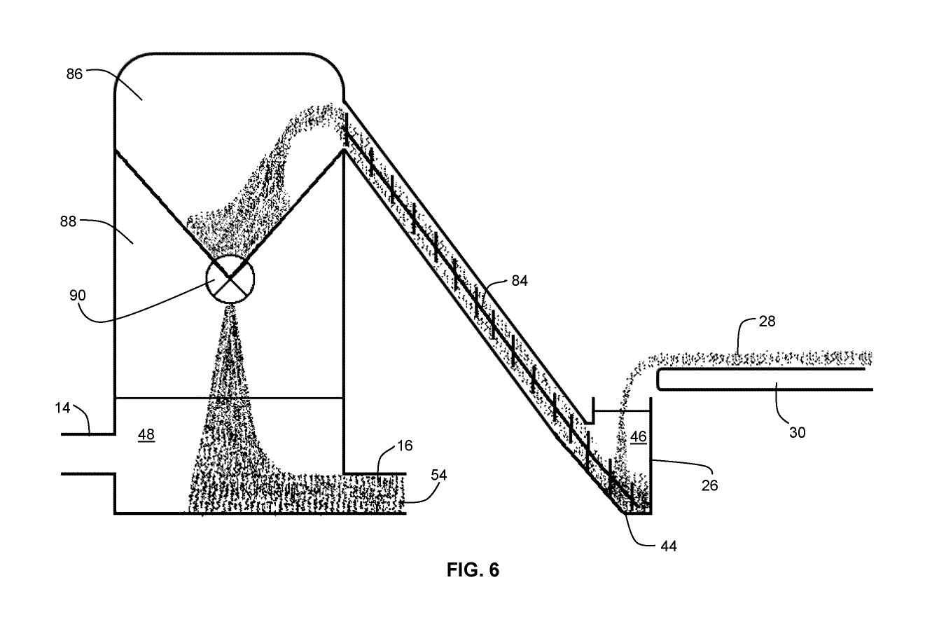

FIG. 6 shows an alternative embodiment of an apparatus used to carry out the present method, which is suitable for use when it is not necessary to handle the transfer fluid or base fluid under conditions of pressure or temperature which are different from environmental conditions. Proppant 28 is transported to hopper 26 by conveyer 30, and is mixed with transfer fluid 46 to pre-condition and purge air from the pores of proppant 28. Concentrated slurry 44 settles at the bottom of hopper 26, is transported by augur 84 to upper chamber 86, and is measured into lower chamber 88 through metering valve 90. A stream of base fluid 48 enters lower chamber 88 through base fluid inlet 14 and mixes with concentrated slurry 44 to form proppant slurry 54, which exits lower chamber 88 through proppant slurry outlet 16 and is pumped to a wellhead (not shown).

As is well understood in the art, in at least one embodiment, operation of the presently described devices and apparatus to carry out the presently described method can be carried out by a computer executing machine-readable code, as is well understood in the art. In such embodiments, one or more process parameters of embodiments of the present method can be measured, determined, and/or controlled by the computer executing a software program. For example, one or more of the rate at which proppant 28 is added to transfer fluid 46 to prepare the transfer slurry 42 or the concentrated slurry 44, the flow rate of transfer slurry 42 at the transfer slurry inlet 12, the level of concentrated slurry 44 in the transfer slurry chamber 60 or the upper chamber 86, the flow rate of base fluid 48 at base fluid inlet 14, and the rate of transfer of concentrated slurry 44 through the proppant transfer device 64 or metering valve 90 can be pre-calculated to provide a desired predetermined flow rate and proppant concentration of proppant slurry 54 at the proppant slurry outlet 16 as required for the particular fracturing job. Operation of one or more of the high pressure pumps 34, proppant transfer device 64 or metering valve 90, pump 22 and mixing device 26 can be adjusted by the program to provide proppant slurry 54 to the wellhead 32 at an appropriate flow rate and pressure based on actual values of these parameters measured during operation. Furthermore, conditions within the transfer slurry chamber and base fluid chamber can be measured and adjusted during operation, including the operation of choke valve 66, so that the pressure within the transfer slurry chamber is maintained to be equal to or greater than the pressure within the base fluid chamber.

### EXAMPLES

Other features of the present invention will become apparent from the following non-limiting examples which illustrate, by way of example, the principles of the invention.

### Example 1

Transfer of Proppant from a Water-Based Slurry to Acid as a Base Fluid

Proppant is mixed with water (density 1000 kg/m³) in a hopper at atmospheric pressure and ambient temperature and allowed to settle to form a concentrated slurry at the bottom of the hopper. The concentrated slurry is transferred at atmospheric pressure and ambient temperature to the upper chamber of an apparatus as illustrated in FIG. 6. The concentrated slurry is allowed to pass through a metering valve, which controls addition of the concentrated slurry to concentrated hydrochloric acid (HCl, 20% w/w, density 1098 kg/m³) in a lower chamber at atmospheric pressure and ambient temperature. The resulting proppant slurry is then pumped to a wellhead using high pressure pumps.

### Example 2

Transfer of Proppant from a Diesel Fuel-Based Slurry to Condensate as a Base Fluid

Gas condensate (density <750 kg/m³, flash point <10° C., Reid vapor pressure about 70 kPa) is pumped at ambient temperature and at a pressure greater than 70 kPa into the base fluid inlet of a proppant exchange chamber as illustrated in FIG. 4 or 5. Proppant is mixed with diesel fuel (density 840 kg/m³, flash point >60° C., Reid vapor pressure less than 1.4 kPa) in a blender at atmospheric pressure and ambient temperature. The resulting transfer slurry is transferred at a pressure greater than the pressure of the gas condensate and ambient temperature to the transfer slurry chamber of the proppant exchange chamber. The transfer slurry is allowed to separate to form a concentrated slurry and the concentrated slurry is transferred, using a proppant transfer device, to the stream of gas condensate or to the base fluid chamber containing the gas condensate. The resulting proppant slurry is then pumped to a wellhead using high pressure pumps. Excess diesel fuel formed when the concentrated slurry forms from the transfer slurry in the transfer slurry chamber can be recovered for reuse.

### Example 3

Transfer of Proppant from a Diesel Fuel-Based Slurry to Liquid CO₂ as a Base Fluid

Proppant is mixed with diesel fuel (density 840 kg/m³, flash point >60° C., Reid vapor pressure less than 1.4 kPa) in a blender at atmospheric pressure and −20° C. The resulting transfer slurry is adjusted to a pressure of at least 2 MPa, and transferred to the transfer slurry chamber of a proppant exchange chamber as illustrated in FIG. 4 or 5. The transfer slurry is allowed to separate to form a concentrated slurry and the concentrated slurry is transferred, using a proppant transfer device, to a stream of liquid CO₂ at −20° C. and 2 MPa or to a base fluid chamber containing liquid CO₂ at −20° C. and 2 MPa (density 1110 kg/m³). The resulting proppant slurry is then pumped to a wellhead using high pressure pumps. Excess diesel fuel formed when the concentrated slurry forms from the transfer slurry in the transfer slurry chamber can be recovered for reuse.

### Example 4

Transfer of Proppant from a Diesel Fuel-Based Slurry to Liquid Propane as a Base Fluid

Proppant is mixed with diesel fuel (density 840 kg/m³, flash point >60° C., Reid vapor pressure less than 1.4 kPa) in a blender at atmospheric pressure and ambient temperature (15° C.). The resulting transfer slurry is adjusted to a pressure of at least 1 MPa, and transferred to the transfer slurry chamber of a proppant exchange chamber as illustrated in FIG. 4 or 5. The transfer slurry is allowed to separate to form a concentrated slurry and the concentrated slurry is transferred, using a proppant transfer device, to a stream of a mixture of 75% propane and 25% butane at ambient temperature (15° C.) and 1 MPa or to a base fluid chamber containing a mixture of 75% propane and 25% butane at ambient temperature (15° C.) and 1 MPa (density about 525 kg/m³). The resulting proppant slurry is then pumped to a wellhead using high pressure pumps. Excess diesel fuel formed when the concentrated slurry forms from the transfer slurry in the transfer slurry chamber can be recovered for reuse.

### Example 5

Transfer of Proppant from a Diesel Fuel-Based Slurry to Acid as a Base Fluid

Proppant is mixed with diesel fuel (density 840 kg/m³, flash point >60° C., Reid vapor pressure less than 1.4 kPa) in a blender at atmospheric pressure and ambient temperature (15° C.). The resulting transfer slurry is transferred to the transfer slurry chamber of a proppant exchange chamber as illustrated in FIG. 5. The transfer slurry is allowed to separate to form a concentrated slurry and the concentrated slurry is transferred, using a proppant transfer device, to a base fluid chamber containing concentrated hydrochloric acid (HCl, 20% w/w, density 1098 kg/m³). The resulting proppant slurry is then pumped to a wellhead using high pressure pumps. Excess diesel fuel formed when the concentrated slurry forms from the transfer slurry in the transfer slurry chamber, and/or separated from the acid in the base fluid chamber and recovered through a return line, can be recovered for reuse.

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

1. A method for preparing a proppant slurry for fracturing a subterranean formation, wherein the proppant slurry comprises a base fluid and a proppant, the method comprising:
preparing a mixture comprising the proppant and a transfer fluid; and
transferring the proppant from the mixture to the base fluid to form the proppant slurry.

2. The method of claim 1 wherein the proppant is transferred from the mixture to the base fluid under the influence of gravity.

3. The method of claim 1 wherein the proppant is transferred from the mixture to the base fluid as a concentrated slurry.

4. The method of claim 3 wherein the concentrated slurry is formed by centrifugation of the mixture.

5. The method of claim 3 wherein the concentrated slurry is formed by settling of the proppant from the mixture under the influence of gravity.

6. The method of claim 1 wherein:
preparing the mixture comprising the proppant and a transfer fluid comprises mixing the proppant with the transfer fluid to form a transfer slurry; and
transferring the proppant from the mixture to the base fluid comprises introducing the transfer slurry into a proppant exchange device; introducing the base fluid into the proppant exchange device; and
transferring the proppant from the transfer slurry to the base fluid to form the proppant slurry and a reclaimed transfer fluid.

7. The method of claim 6 wherein the proppant is transferred from the transfer slurry to the base fluid as a concentrated slurry.

8. The method of claim 7 wherein the concentrated slurry is formed by centrifugation of the mixture.

9. The method of claim 7 wherein the concentrated slurry is formed by settling of the proppant from the mixture under the influence of gravity.

10. The method of claim 6 wherein:
the transfer fluid has a transfer fluid density, the base fluid has a base fluid density which is greater than the transfer fluid density and the proppant has a proppant density which is greater than each of the transfer fluid density and the base fluid density; and
the transfer slurry and the base fluid are in mutual direct contact within the proppant exchange device, and the proppant is transferred from the transfer slurry to the base fluid under the influence of gravity.

11. The method of claim 6 wherein the transfer fluid and the base fluid are immiscible.

12. The method of claim 1 wherein the base fluid is a noxious or corrosive base fluid.

13. The method of claim 1 wherein the base fluid and the proppant slurry are maintained in a closed system.

14. The method of claim 6 wherein the base fluid and the proppant slurry are maintained in a closed system, and the base fluid is selected from a liquefied gas and a volatile base fluid having a Reid vapour pressure greater than 14 kPa or greater than 2 psi, wherein the base fluid is maintained at one or more of a controlled temperature and a controlled pressure and the transfer slurry is adjusted to one or more of the controlled temperature and a pressure equal to or higher than the controlled pressure prior to introduction into the proppant exchange device.

15. A proppant exchange chamber comprising:
a transfer slurry inlet for introduction of a transfer slurry into the proppant exchange chamber, the transfer slurry comprising a proppant and a transfer fluid, wherein the transfer fluid has a transfer fluid density and the proppant has a proppant density which is greater than the transfer fluid density;
a base fluid inlet for introduction of a base fluid into the proppant exchange chamber, the base fluid inlet being positioned below a position of the transfer slurry inlet, the base fluid having a base fluid density which is greater than the transfer fluid density, wherein when the transfer slurry is brought into direct contact with the base fluid in the proppant exchange chamber, the proppant is transferred from the transfer slurry to the base fluid under the influence of gravity to form a proppant slurry and a reclaimed transfer fluid;
a proppant slurry outlet for removal of the proppant slurry from the proppant exchange chamber; and
a reclaimed transfer fluid outlet for removal of the reclaimed transfer fluid from the proppant exchange chamber.

16. A proppant exchange device comprising:
a transfer slurry chamber comprising:
a transfer slurry inlet for introduction of a transfer slurry into the transfer slurry chamber, the transfer slurry comprising a proppant and a transfer fluid, wherein the transfer slurry separates within the transfer slurry chamber to form a concentrated slurry and a reclaimed transfer fluid, and
a reclaimed transfer fluid outlet for removal of the reclaimed transfer fluid from the transfer slurry chamber;
a base fluid chamber comprising:
a base fluid inlet for introduction of a base fluid into the base fluid chamber; and
a proppant slurry outlet for removal of a proppant slurry from the base fluid chamber; and
a proppant transfer device providing transfer of the concentrated slurry from the transfer slurry chamber to the base fluid chamber for mixing with the base fluid to form the proppant slurry.

17. The proppant exchange device according to claim 16 wherein the proppant transfer device comprises at least one component selected from a valve, an augur, a bulk solids pump and a positive displacement solid feed device.

18. The proppant exchange device according to claim 16 wherein the base fluid chamber further comprises a purge line.

19. The proppant exchange device according to claim 16 further comprising a return line for return of fluid from the base fluid chamber to the transfer slurry chamber.
